(19) United States
(12) Patent Application Publication
(10) Pub. No.: US 2023/0186034 A1
(43) Pub. Date: Jun. 15, 2023

(54) Electronic Message Response Processing

(71) Applicant: Citrix Systems, Inc., Fort Lauderdale, FL (US)

(72) Inventor: Ryan Matthew Casper, Conway, AR (US)

(21) Appl. No.: 17/550,164

(22) Filed: Dec. 14, 2021

(51) Int. Cl. G06F 40/40; G06F 40/226; G06F 40/166; G06F 40/106; H04L 51/046

(52) U.S. Cl. CPC G06F 40/40; G06F 40/226; G06F 40/166; G06F 40/106; H04L 51/046

(57) ABSTRACT

Methods and systems for message response processing are described herein. A computing system may generate an input based on a plurality of messages, the input including content of the plurality and a prompt for an outcome, the plurality of messages including a received message and another message yet to be sent, and the outcome indicative of a level of responsiveness of the another message to the received message. The computing platform may determine the outcome responsive to the prompt based on the content of the plurality of messages included in the input. The computing platform may provide the outcome to a computing device before transmission of the another message, the outcome to enable modification the another message to adjust responsiveness of the another relative to the received message.

### FIELD

Aspects described herein generally relate to computer networking, electronic messaging systems, and hardware and software related thereto. More specifically, one or more aspects described herein provide techniques to process responses to electronic messages.

### BACKGROUND

During electronic messaging or textual message exchanges (e.g., chat, text messaging, or the like), frequently, questions may be asked or information may be sought. For example, a message drafter may compose a message at a first device, which may send the message to a second device (e.g., of a message recipient) over a wired or wireless communication network. The message recipient may be responsible for reading the message and responding (e.g., via the same wired or wireless communication network) accordingly.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

Hasty responses from a message respondent may cause unnecessary exchanges, confusion, or otherwise offend a recipient. This may lead to misunderstanding of questions, and/or misinterpreting the tone of a message may reduce efficiency and throughput of online communication. Such misunderstanding can reduce the effectiveness of electronic messaging because messages may be incomplete or otherwise convey the wrong information either implicitly or explicitly (or both). For instance, receipt of an incomplete messages may require further generation and communication of additional messages to obtain the entirety of the information sought. Similarly, messages that convey the wrong or inaccurate information may require additional messages as well to clarify previous messages received. In either situation, poorly generated or otherwise inaccurate messages increases the total number of messages handled by messaging systems. In turn, message processing systems use more computing resources to process these additional messages than would be necessary if the message was properly generated in the first place. Accordingly, prevention of such miscommunication may be progressively important as the amount of electronic communication continues to increase.

To overcome limitations in the prior art described above, and to overcome other limitations that will be apparent upon reading and understanding the present specification, aspects described herein are directed towards processing message responses.

In one or more embodiments described herein, a computing system may generate an input based on a plurality of messages, the input including content of the plurality and a prompt for an outcome, the plurality of messages including a received message and another message yet to be sent, and the outcome indicative of a level of responsiveness of the another message to the received message. The computing system may determine the outcome responsive to the prompt based on the content of the plurality of messages included in the input. The computing system may provide the outcome to a computing device before transmission of the another message, the outcome to enable modification the another message to adjust responsiveness of the another relative to the received message.

In one or more instances, the content may indicate one or more questions included in the received message. In one or more instances, the content may indicate responses to the one or more questions.

In one or more examples, the outcome may indicate whether or not text of the another message is relevant to the one or more questions. In one or more examples, providing the outcome to the computing device may include causing the computing device to: 1) display, within an interface used to compose the another message, the outcome, and 2) highlight, within the outcome, a portion of text of the received message not addressed by text of the another message.

In one or more instances, determining the outcome may include determining the outcome using one or more natural language processing (NLP) models, and the one or more NLP models include one of more of: a general language model and a valid response model. In one or more instances, the plurality of messages may include one or more of: email messages, text messages, or chatroom messages.

In one or more examples, providing the outcome may include autocompleting the prompt. In one or more examples, the content may be sent by a client device in response to receiving, at the client device, a user input indicating that the another message should be sent.

In one or more instances, the content may be sent by a client device in real time as the another message is composed. In one or more instances, the computing system may receive, along with the content, additional content indicating previous messages included on a messaging string along with the received message and the another message, where generating the input further comprises generating, based on the additional content, the input.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIGS. 3A-3B depict an illustrative computing architecture that may be used to process electronic messages in accordance with one or more illustrative aspects described herein.

FIGS. 4A-4B depict an illustrative event sequence that may be used to process electronic messages in accordance with one or more illustrative aspects described herein.

FIG. 5 depicts an illustrative method that may be used to process electronic messages in accordance with one or more illustrative aspects described herein.

FIGS. 6A-6B depict illustrative user interfaces for processing electronic messages in accordance with one or more illustrative aspects described herein.

FIGS. 7 and 8 depict illustrative user interfaces for processing electronic messages in accordance with one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed towards identifying miscommunication and/or misunderstanding in electronic communication. A plugin may be integrated into a message authoring program (e.g., an email or text messaging application) that may evaluate a received messages and the real-time typed response of the responding user. In other instances, the message application may otherwise evaluate a received message and the corresponding response without the use of an integrated plugin. For example, the message pair may be submitted to a contextually-trained or general knowledge Natural Language Processing (NLP) system.

While typing (or when the send button is clicked), the message response may be evaluated to identify whether or not it is structured as a relevant message response to the questions or queries in the original message (e.g., does the response answer all questions, provide all requested information, and/or otherwise constitute a complete response to the initial message). If the evaluation indicates that the response is of low relevance to the original message, or if it detects that there are questions unanswered, the user may be warned about the problem, and given the opportunity to review or modify the message before it is actually sent.

A similar mechanism may be applied to interactive chat programs and mobile text messaging. In some examples, in such instances, a chatbot warning may be sent to the user to edit or follow-up with their response to improve and clarify their message.

Using the above described methods, people responding to email and other messages may receive a warning or notification if the response they are writing is unexpected in the given context.

NLP engines may provide deep and nuanced understanding of textual conversations. For example, using NLP, NLU, and/or other language understanding may be used to detect non-sequiturs, confused responses, or answers that might not address/apply to questions when generating or evaluating text inputs.

By implementing the methods described above (and described in further detail below), deep analysis may be performed about whether a reply message's content naturally follows along with recommended guidance or examples. By making the user aware that a response might not match a question (or if it left questions unanswered) it may alert the user to re-read the original email more carefully before sending their response. This may virtually eliminate a large swath of miscommunications that may happen online, and may make humans more efficient at communication in their day-to-day lives.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

Computing Architecture

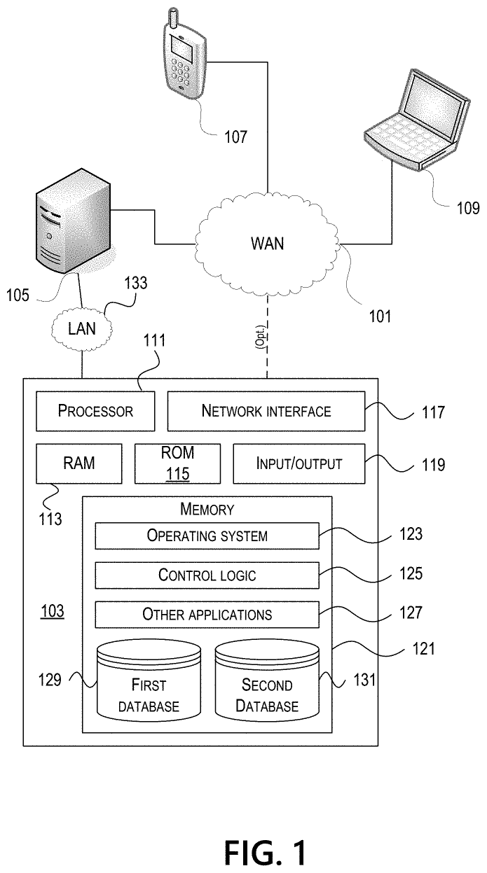

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

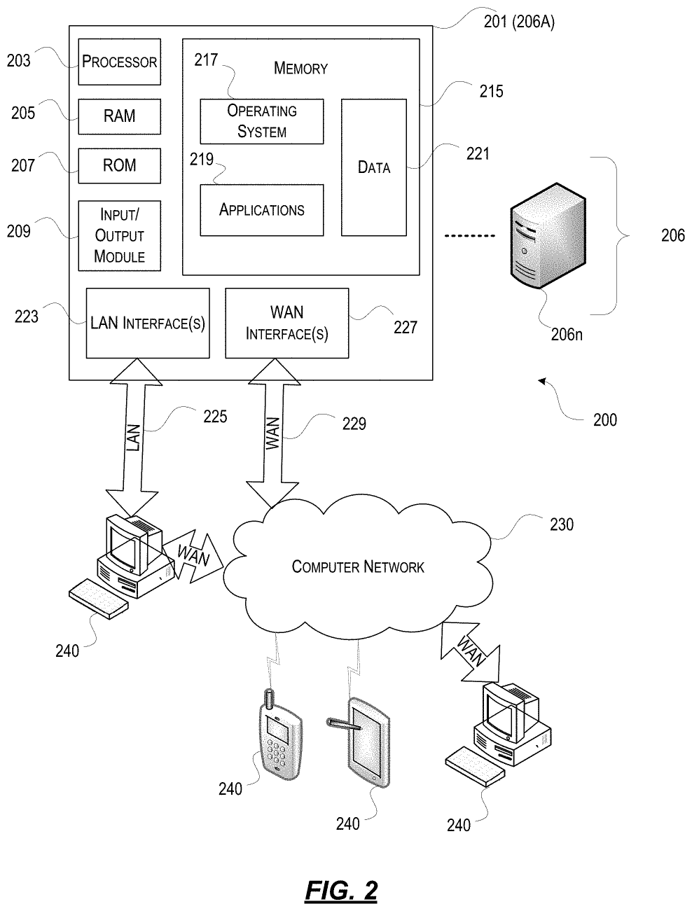

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Fla.; or the Remote Desktop Protocol (RDP) manufactured by the Microsoft Corporation of Redmond, Wash.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

Electronic Message Response Processing

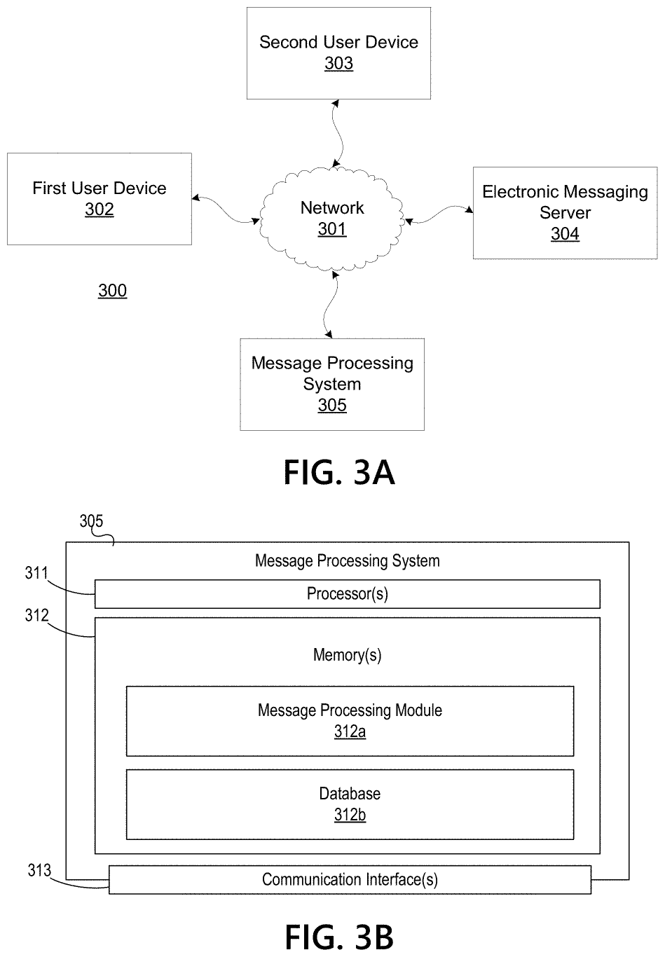

FIGS. 3A and 3B depict an illustrative computing environment for processing electronic messages in accordance with one or more example embodiments. Referring to FIG. 3A, computing environment 300 may include one or more computer systems. For example, computing environment 300 may include a first user device 302, second user device 303, electronic messaging server 304, and a message processing system 305.

First user device 302 (which may, e.g., be a computing device similar to devices 107 or 109, shown in FIG. 1, or client machine 240, shown in FIG. 2) may include one or more computing devices configured to perform one or more of the functions described herein. For example, first user device 302 may be a mobile device, a tablet, a smart phone, laptop computer, desktop computer, or the like. In some instances, the first user device 302 may be configured to support one or more electronic messaging services (e.g., electronic messaging, text messaging, chatroom messaging, instant messaging, and/or other types of electronic messaging). In some instances, the first user device 302 may be configured to display one or more graphical user interfaces (e.g., electronic messaging interfaces).

Second user device 303 (which may, e.g., be a computing device similar to devices 107 or 109, shown in FIG. 1, or client machine 240, shown in FIG. 2) may include one or more computing devices configured to perform one or more of the functions described herein. For example, second user device 303 may be a mobile device, a tablet, a smart phone, laptop computer, desktop computer, or the like. In some instances, the second user device 303 may be configured to support one or more electronic messaging services (e.g., electronic messaging, text messaging, chatroom messaging, instant messaging, and/or other types of electronic messaging). In some instances, the second user device 303 may be configured to display one or more graphical user interfaces (e.g., electronic messaging interfaces).

Electronic messaging server 304 (which may be similar to web server 105 or data server 103, shown in FIG. 1, and/or computing device 201 or server 206, shown in FIG. 2) may be a computer system that includes one or more computing devices and/or other computer components (e.g., processors, memories, communication interfaces, servers, server blades, or the like). In addition, electronic messaging server 304 may be configured to host or otherwise support an electronic messaging service, which may be used by various user devices (e.g., first user device 302, second user device 303, and/or other user devices) to communicate.

As illustrated further below, natural language processing system 305 (which may be similar to web server 105 or data server 103, shown in FIG. 1, and/or computing device 201 or server 206, shown in FIG. 2), may maintain and/or otherwise host one or more natural language processing models (e.g., general language model, valid response model, and/or other models). In some instances, message processing system 305 may be configured to identify or otherwise detect miscommunication, misinterpretation, and/or other errors in messages sent between users (e.g., between first user device 302, second user device 303, electronic messaging server 304, and/or other devices). For example, the message processing system 305 may be configured to perform natural language processing, natural language understanding, and/or other language processing/understanding methods to perform such identification and/or detection. In some instances, services, features, and functionality described below with regard to the message processing system 305 may be integrated into or otherwise integrated into various enterprise services such as an isolated web browsing service, an electronic messaging application, a remote access service, and/or other services.

Computing environment 300 may also include one or more networks, which may interconnect first user device 302, second user device 303, electronic messaging server 304, and message processing system 305. For example, computing environment 300 may include a network 301 (which may e.g., interconnect first user device 302, second user device 303, electronic messaging server 304, and/or message processing system 305). In some instances, the network 301 may be similar to computer network 230, which is shown in FIG. 2.

In one or more arrangements, first user device 302, second user device 303, electronic messaging server 304, message processing system 305, and/or the other systems included in computing environment 300 may be any type of computing device capable of receiving a user interface, receiving input via the user interface, and communicating the received input to one or more other computing devices. For example, first user device 302, second user device 303, electronic messaging server 304, message processing system 305, and/or the other systems included in computing environment 300 may in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of first user device 302, second user device 303, electronic messaging server 304, and/or message processing system 305 may, in some instances, be special purpose computing devices configured to perform specific functions.

Referring to FIG. 3B, message processing system 305 may include one or more processors 311, memory 312, and communication interface 313. A data bus may interconnect processor 311, memory 312, and communication interface 313. Communication interface 313 may be a network interface configured to support communication between the message processing system 305 and one or more networks (e.g., network 301, or the like). Memory 312 may include one or more program modules having instructions that when executed by processor 311 cause message processing system 305 to perform one or more functions described herein and/or access one or more databases that may store and/or otherwise maintain information which may be used by such program modules and/or processor 311. In some instances, the one or more program modules and/or databases may be stored by and/or maintained in different memory units of message processing system 305. For example, message processing system 305 may have, host, store, and/or include a natural language processing module 312a. Message processing module 312a may enable or otherwise perform message analysis (e.g., using natural language processing, natural language understanding, pattern matching, user-defined rules/policies, sentiment analysis, Bayesian/statistical classification, and/or other language processing techniques) to identify potential miscommunication, as described in greater detail below. Database 312b may store or otherwise host information that may support the analysis performed by the message processing module 312a and/or the message processing system 305.

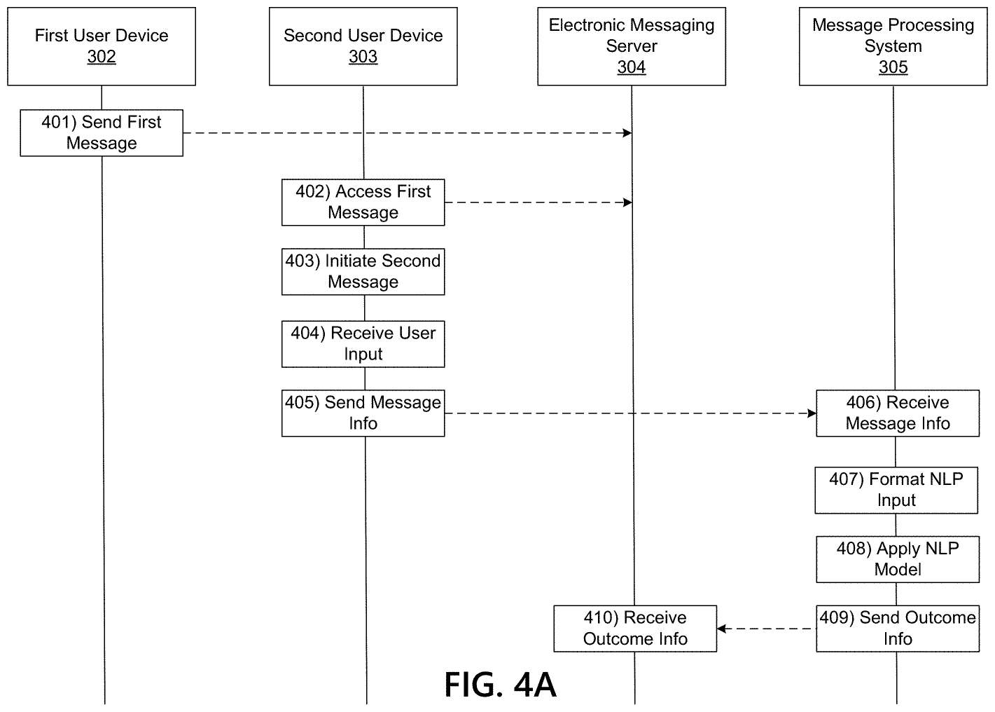

FIGS. 4A and 4B depict an illustrative event sequence for processing electronic messages in accordance with one or more example embodiments. It should be understood that steps 401-416 may, in some instances, occur in the order as shown with regard to FIGS. 4A and 4B. For example, after completing step 410 of FIG. 4A, the event sequence may proceed to step 411 of FIG. 4B.

Referring to FIG. 4A, at step 401, the first user device 302 may send a first message. For example, the first user device 302 may send an email, a short message service (SMS) message, a chat message, an instant message, and/or other message. In some instances, the first user device 302 may send the first message using an email authoring program, a text messaging application, and/or other application, which may access an electronic messaging server 304 or otherwise access a browser extension to send the first message to an intended recipient (who may, e.g., be the user of the second user device 303).

At step 402, the second user device 303 may access the first message. For example, the second user device 303 may access the first message via an application (e.g., email authoring program, a text messaging application, a browser), which may access the electronic messaging server 304 or otherwise access a browser extension to receive the first message from the message sender (e.g., the user of the first user device 302).

At step 403, the second user device 303 may initiate a second message, which may be a reply to the first message. For example, the second user device 303 may initiate the second message via an email authoring program, a text messaging application, and/or other application.

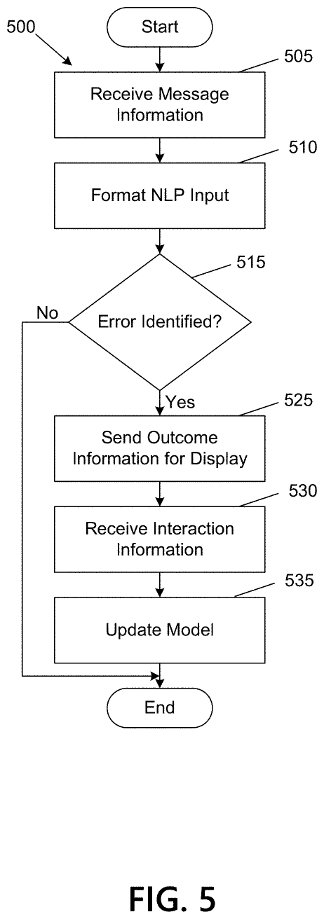

At step 404, the second user device 303 may receive user input indicating text to include in the second message. For example, the second user device 303 may receive user input indicating text intended to reply to one or more questions within the first message. For example, the second user device 303 may display a graphical user interface similar to graphical user interface 605, which is illustrated in FIG. 6A, and which depicts both the first message and the second message (which may, in some instances, be displayed as part of a messaging string or chain).

At step 405, the second user device 303 may send first message information, indicating the text of the first message, and second message information, indicating the text of the second message, to the message processing system 305 for analysis. In some instances, the second user device 303 may send the first message information and the second message information to the message processing system 305 in response to receiving user input requesting to send the second message. In other instances, the second user device 303 may send the first message information and the second message information to the message processing system 305 in response to detecting any portion of the user input received at step 404. For example, the second user device 303 may detect, in substantially real time, that the user is typing a response to the first message, and may send this information to the message processing system 305 before completion of the second message to obtain real time analysis and provide real time recommendations.

In some instances, rather than sending the first message information and the second message information directly to the message processing system 305, the second user device 303 may send the first message information and the second message information to electronic messaging server 304 (or a corresponding plug in such as a messaging program or email server plug in). In these instances, the electronic messaging server 304 may then coordinate delivery of the first message information and the second message information to the message processing system 305. Similarly, in these instances, communication from the message processing system 305 to the second user device 303 may be transmitted through or otherwise facilitated by the electronic messaging server 304. At step 406, the message processing system 305 may receive the first message information and the second message information from the second user device 303.

At step 407, the message processing system 305 may format an NLP input (e.g., the message processing system 305 may convert the first message information and the second message information into an input understandable by a natural language processing model) based on the first message information, the second message information, and an outcome prompt (which may be, e.g., “Outcome:” to set up a response from the natural language processing model indicating how responsive the second message is to the first message). In doing so, the message processing system 305 may include text from the first message in its entirety along with text from the second message in its entirety. For example, the text of the first message was “Are we ready to go for the new product release? Did we get the product description ready?” and the text of the second message included “The release is ready to go!” In this example, the message processing system 305 may create input that recites “Question: Are we ready to go for the new product release? Did we get the product description ready?; Response: The release is ready to go!; Outcome:”. In doing so, the message processing system 305 may provide that input to one or more NLP models for analysis and auto completion, which may allow the message processing system 305 to provide an outcome worded in text.

Additionally or alternatively, the message processing system 305 may include only a portion of the text from the first message (rather than including this text in its entirety). For example, a user may be responding inline to an email or document, and relevant text from the first message (e.g., text being responded to) may be provided as the input to the one or more NLP models.

In some instances, the message processing system 305 may generate input based on additional information beyond the first message and the second message. For example, in some instances, the message processing system 305 may receive an entire message chain that includes the first message and the second message (e.g., an email chain, a text chain, a chatroom transcript, or other message string). In these instances, the message processing system 305 may extract all text from the message chain, and may use the text to create a text string that may be input into the natural language processing model (e.g., the text string may be “Text from first message, text from second message, text from third message . . . ”). Furthermore, although the steps described above illustrate two individuals, any number of individuals may be included or otherwise be participating in the messaging chain, and the conversation between this plurality of individuals may be used to create the input (and thus may subsequently be analyzed as described below). For example, the above described methods may be used in a shared chat environment with greater than two participants, and may be used to provide assistance to all participants (e.g., identify unanswered questions, or perform other services).

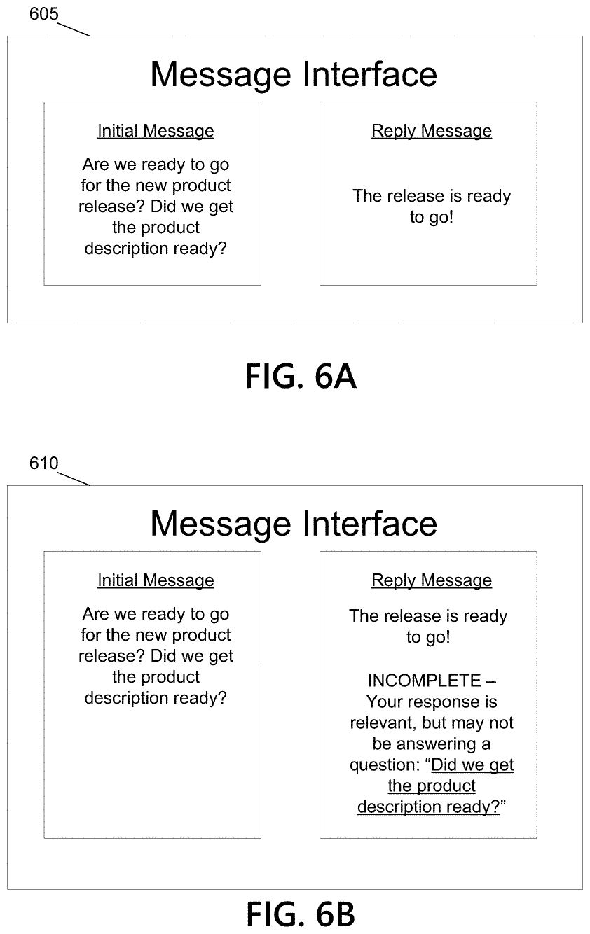

At step 408, the message processing system 305 may apply one or more NLP models to the input. For example, the message processing system 305 may use a general language model to analyze the input. In this example, the message processing system 305 may feed a finite number of questions, responses, and outcomes to the general language model, which may enable the model to identify a degree of responsiveness of the text of the second message to one or more questions of the first message (e.g., whether or not the response is relevant to the questions). Similarly, in doing so, the message processing system 305 may enable the system 305 to identify whether or not every question in the first message is addressed in the second message (e.g., the second message may include a response to one question from the first message, but not another). Once enabled in this way, the message processing system 305 may use the general language model to autocomplete the outcome prompt provided in the input. For example, to continue with the example described above, the message processing system 305 may output “Question: Are we ready to go for the new product release? Did we get the product description ready?; Response: The release is ready to go!; Outcome: INCOMPLETE—Your response is relevant, but may not be answering a question: ‘Did we get the product description ready.” In some instances, the output may be formatted as illustrated in message 705, which is illustrated in FIG. 7. For example, in addition to outputting insight indicating whether or not all questions have been responded to and whether a relevant reply has been composed, the general language model may output a specific portion of the first message that was not addressed in the second message. In doing so, the general language model may provide recommended information to include in the second message based not only on text included in the second message, but also based on text included in the first message. In some further examples, the system presents text, included in the first message, that is not addressed in the second message (e.g., calling attention to specific bits that may need to be handled). In some instances, this text may be highlighted and/or may include a flag indicating “Possibly overlooked question or topic,” and/or other visual hints/warnings to provide context on what is being overlooked in the second message.

In some instances, rather than identifying a response as “INCOMPLETE,” the general language model may identify an outcome of “GOOD” or “BAD.” For example, in the case of the input “QUESTION: Do you have that document on our sales quotes from 2021?; RESPONSE: Attached is the document on our sales quotes from 2021. Outcome:”, the general language model may output “QUESTION: Do you have that document on our sales quotes from 2021?; RESPONSE: Attached is the document on our sales quotes from 2021. Outcome: GOOD—Your response is relevant to the question (because it responds specifically about the sales quote for the right year.”

As another example, in the case of the input “QUESTION: Do you have that document on our sales quotes from 2021?; RESPONSE: Attached is the document on our sales quotes from 2012. Outcome:”, the general language model may output “QUESTION: Do you have that document on our sales quotes from 2021?; RESPONSE: Attached is the document on our sales quotes from 2012. Outcome: BAD—Your response is not relevant to the question (because it mentions 2012 rather than 2021)”. In doing so, rather than merely identifying the second message is unresponsive, the message processing system 305 may provide insight into why the second message is unresponsive (e.g., the wrong year is referenced).

Accordingly, by using the general language model (e.g., a natural language processing model that is generic and not configured based on any specific context or user), the message processing system 305 may identify whether text in the second message is irrelevant (e.g., “BAD”), incomplete (e.g., not answering all questions), or good (e.g., both complete and responsive) in the context of responding to text in the first message. Furthermore, the message processing system 305 may perform actual understanding of the meaning of what is being asked for in the first message (e.g., from the original sender) and the core of what is being provided as a response in the second message (e.g., from the current responder) to be sure they go together (e.g., taking account the contents of both the original and reply messages). For example, if the first message requests a file/attachment, and the second message does not refer to it or reference it, the message processing system 305 may notify the drafter of the second message. In addition, in some instances, the message processing system 305 may identify specific documents and/or references if a variety were requested. For example, the first message may request three different documents, and the message processing system 305 may identify if the second message fails to reference/include all three.

Additionally or alternatively, in some instances, the message processing system 305 may identify whether a tone of the second message matches a tone of the first message or whether the second message may appear offensive or otherwise rude based on the corresponding tone (e.g., by analyzing the text of both messages using natural language processing and/or understanding, and comparing the text to other offensive text, contexts, or otherwise).

Additionally or alternatively, the message processing system 305 may use a valid response model (e.g., a natural language processing model that is configured or otherwise trained based on a specific context or user, and may be dynamically refined based on user input indicating whether or not various outputs are valid) to analyze the input. In these instances, the message processing system 305 may have previously trained the valid response model to distinguish between irrelevant, incomplete, and/or responsive/complete message responses, and/or to identify a recommended or standardized format for specific messages. In some instances, the message processing system 305 may apply the valid response model in instances where a more specialized response/context is important. For example, rather than using a general language model (which may, e.g., provide more generic classification), the message processing system 305 may use the valid response model to perform analysis for a specific group of individuals (e.g., a particular department or job role within an enterprise, such as customer service communication, legal communication, or other specialized communications), a specific message format (e.g., SMS, email, chat, and/or other message formats), and/or if other specific considerations are present (e.g., a particular answer format is to be used, or the like). Additionally or alternatively, the message processing system 305 may train individualized valid response models for various individuals, pairs of individuals, and/or other pluralities of specific individuals, and may uses these personalized models to provide a response.

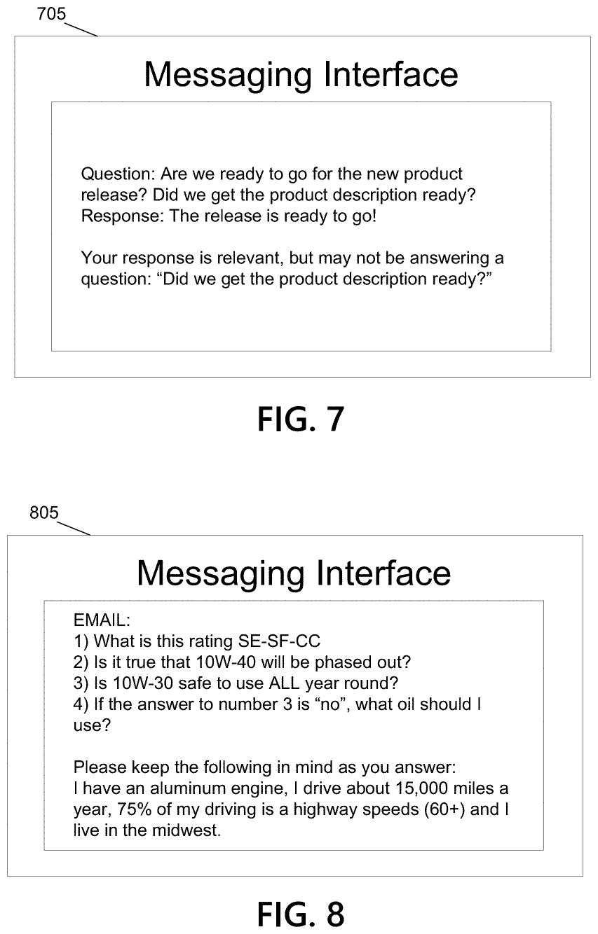

As a particular example, specific rules may be identified for the second message based on the context of the first message. For example, the first message may be “1) What is this rating SE-SF-CC?; 2) Is it true that 10W-40 will be phased out?; 3) Is 10W-30 safe to use all year round?; 4) If the answer to number 3 is “no,” what oil should I use?” In some instances, the first message may be formatted as illustrated in message 805, which is illustrated in FIG. 8. In this example, the valid response model may identify that the first message includes 4 questions, that the first answer should be a definition or explanation, that the second answer should be true/false (with an explanation), that the third answer should be true/false (with an explanation), and that the fourth response should be a recommendation (contingent on the answers to the previous question). The valid response model may then analyze the text of the second message to identify whether or not it conforms with this format. In some instances, in generating the outcome information, the message processing system 305 may include this recommended answer format in the outcome information. In instances where the valid response model is used, the message processing system 305 may produce outcome information in a format similar to the outcome information output by the general language model.

Additionally or alternatively, in some instances, the message processing system 305 may identify whether a tone of the second message matches a tone of the first message or whether the second message may appear offensive or otherwise rude based on the corresponding tone. For example, the message processing system 305 may analyze message formats, an amount of slang used, a generate message tone, information included in the messages, and/or other information to analyze message tone (e.g., using natural language processing, natural language understanding, and/or other techniques). If such tone analysis is performed (using the general language model, the valid response model, or both), the results of such analysis may be included as information in the form of an outcome.

In some instances, the message processing system 305 may apply both the general language model and the valid response model, and, in some instances, may compare the outputs to identify an output. For example, if both models produce the same (or substantially the same) outcome, the message processing system 305 may trust the outcome, whereas if the models do not produce the same outcome, the message processing system 305 may either select one of the responses (e.g., based on a confidence level or trust score, which may be associated with the particular outcomes or models) and/or re-apply the models.

At step 409, the message processing system 305 may send information in the form of an outcome to the electronic messaging server 304 and/or otherwise communicate the outcome information to the second user device 303. In some instances, the message processing system 305 may modify the information for display prior to sending the information to the electronic messaging server 304 and/or the second user device. For example, the message processing system 305 may modify the information for display to emphasize a particular question that was not answered, show why a response is irrelevant, and/or otherwise convey to the user of the second user device 303 any errors or miscommunication in the second message. In some instances, along with the outcome information, the message processing system 305 may send one or more commands directing the electronic messaging server 304 and/or the second user device 303 to display the information and/or modify the information for display. In these instances, the above described modifications to information indicative of an outcome may be performed by the electronic messaging server 304 and/or the second user device 303.

At step 410, the electronic messaging server 304 and/or the second user device 303 may receive information indicative of an outcome. In some instances, the electronic messaging server 304 and/or the second user device 303 may also receive the one or more commands directing the electronic messaging server 304 and/or the second user device 303 to display the information and/or modify the information for display.

At step 411, based on or in response to the one or more commands directing the electronic messaging server 304 and/or the second user device 303 to modify the information for display, the electronic messaging server 304 and/or the second user device 303 may format the information as described above (e.g., to emphasize a particular question that was not responded to or why a response is otherwise irrelevant). For example, the electronic messaging server 304 and/or the second user device 303 may extract a particular question that was not answered, add it to the outcome information (if it is not already included), and highlight, underline, or otherwise emphasize the question. For example, the formatted outcome information may be “Question: Are we ready to go for the new product release? Did we get the product description ready?; Response: The release is ready to go!; Outcome: INCOMPLETE—Your response is relevant, but may not be answering a question: ‘Did we get the product description ready.”

At step 412, the second user device 303 may access the formatted outcome information (assuming the outcome information was not formatted at the second user device 303 itself), and may then display the formatted outcome information. In some instances, the second user device 303 may display the formatted outcome information based on or in response to the one or more commands from the message processing system 305 directing the second user device 303 to display the outcome information. For example, the second user device 303 may display a graphical user interface similar to graphical user interface 610, which is illustrated in FIG. 6B, and which shows outcome information for the second message, indicating that it is unresponsive or otherwise irrelevant to the first message, and providing specific text that should be modified or is otherwise not addressed.

At step 413, the second user device 303 may receive user input indicating whether the formatted information will be ignored or addressed. For example, the second user device 303 may receive user input indicating that the second message may be sent as is, or whether it may be modified based on the formatted information.

At step 414, if the message processing system 305 is implementing the valid response model, the second user device 303 may send data, indicating how the user of the second user device 303 interacted with the formatted information, to the message processing system 305. At step 415, the message processing system 305 may receive this data. At step 416, the message processing system 305 may use the data to refine, adjust, re-enforce, and/or otherwise dynamically update the valid response model to improve accuracy of the model over time. Additionally or alternatively, the message processing system 305 may use this data to identify whether or not a user is complying with a network policy (e.g., regarding whether or not this service is being used and/or the suggestions are being complied with).

In some instances, the above described methods may be performed in real time as the second message is being composed. Accordingly, in these instances, the method may loop back to step 404 to receive additional user input for the second message. In some instances, the above described methods may be performed in response to a user completing the second message and requesting that it be sent. In these instances, once the above described steps have been performed, the method may be complete (or in some instances, the user may request to rerun the analysis, and thus the method may return to step 405).

In some instances, the service may be selectively applied. For example, in some instances, individuals may opt into the service. In other instances, an enterprise or network policy may indicate which communications the service should analyze (e.g., apply to external communication but not internal, or the like). By selectively applying the service in this way, processing/computing resources may be conserved by avoiding additional or unnecessary analysis.

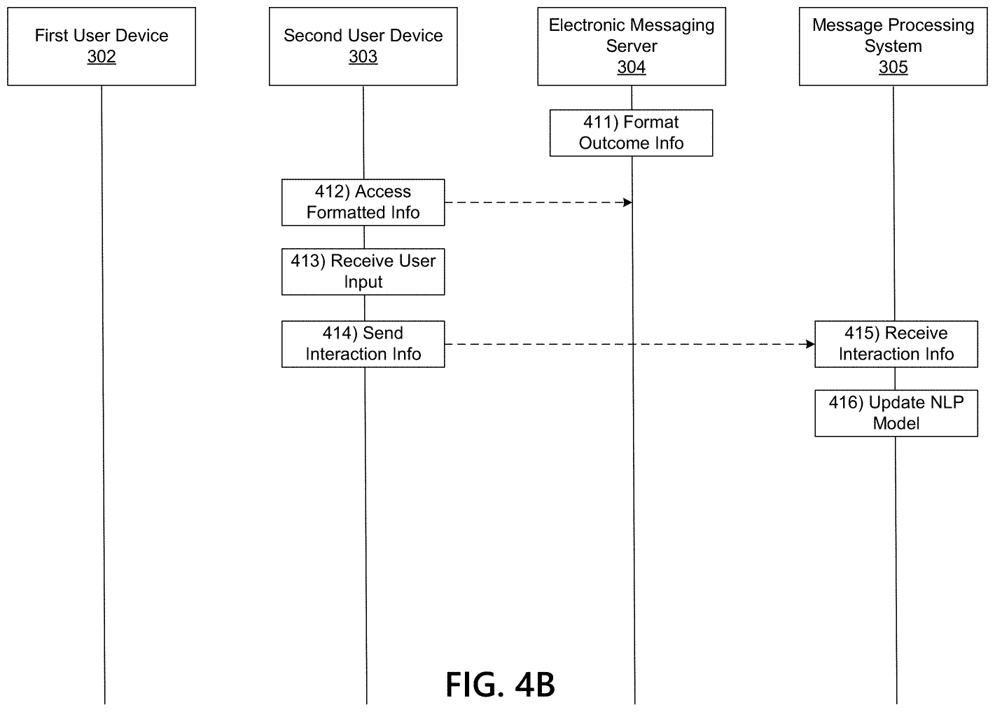

FIG. 5 depicts an illustrative method 500 for electronic message processing in accordance with one or more example embodiments. For example, at step 505, a computing platform may receive message information including the text of at least a first message and a second message replying to the first message. At step 510, the computing platform may generate an input that includes text of the first message, text of the second message, and an outcome prompt. At step 515, the computing platform may identify whether or not any errors were identified. If not, the method may end. If any errors were identified, the computing platform may proceed to step 525.

At step 525, the computing platform may send information indicative of an outcome for display at a user device being used to draft the second message. At step 530, the computing platform may receive data from the user device indicating whether or not the user of the user device ignored the outcome information. At step 535, the computing platform may optionally adjust the evaluation of the input based on the received data.

The following paragraphs (M1) through (M11) describe examples of methods that may be implemented in accordance with the present disclosure.

(M1) A method comprising generating an input based on a plurality of messages, the input including content of the plurality and a prompt for an outcome, the plurality of messages including a received message and another message yet to be sent, and the outcome indicative of a level of responsiveness of the another message to the received message; determining the outcome responsive to the prompt based on the content of the plurality of messages included in the input; and providing the outcome to a computing device before transmission of the another message, the outcome to enable modification the another message to adjust responsiveness of the another relative to the received message.

(M2) A method may be performed as described in paragraph (M1) wherein the content indicates one or more questions included in the received message.

(M3) A method may be performed as described in paragraph (M2) wherein the content indicates responses to the one or more questions.

(M4) A method may be performed as described in any of paragraphs (M2) through (M3) wherein the outcome indicates whether or not text of the another message is relevant to the one or more questions.

(M5) A method may be performed as described in any of paragraphs (M2) through (M4) wherein providing the outcome to the computing device comprises causing the computing device to: display, within an interface used to compose the another message, the outcome, and highlight, within the outcome, a portion of text of the received message not addressed by text of the another message.

(M6) A method may be performed as described in any of paragraphs (M1) through (M5), wherein determining the outcome comprises determining the outcome using one or more natural language processing (NLP) models, and wherein the one or more NLP models include one of more of: a general language model and a valid response model.

(M7) A method may be performed as described in any of paragraphs (M1) through (M6) wherein the plurality of messages comprise one or more of: email messages, text messages, or chatroom messages.

(M8) A method may be performed as described in any of paragraphs (M1) through (M7) wherein providing the outcome comprises autocompleting the prompt.

(M9) A method may be performed as described in any of paragraphs (M1) through (M8) wherein the content is sent by a client device in response to receiving, at the client device, a user input indicating that the another message should be sent.

(M10) A method may be performed as described in any of paragraphs (M1) through (M9) wherein the content is sent by a client device in real time as the another message is composed.

(M11) A method may be performed as described in any of paragraphs (M1) through (M10) further comprising: receiving, along with the content, additional content indicating previous messages included on a messaging string along with the received message and the another message, wherein generating the input further comprises generating, based on the additional content, the input.

The following paragraphs (A1) through (A8) describe examples of apparatuses that may be implemented in accordance with the present disclosure.

(A1) An apparatus comprising a processor; memory storing computer executable instructions that, when executed by the processor, cause the computing system to: generate an input based on a plurality of messages, the input including content of the plurality and a prompt for an outcome, the plurality of messages including a received message and another message yet to be sent, and the outcome indicative of a level of responsiveness of the another message to the received message; determine the outcome responsive to the prompt based on the content of the plurality of messages included in the input; and provide the outcome to a computing device before transmission of the another message, the outcome to enable modification the another message to adjust responsiveness of the another relative to the received message.

(A2) An apparatus as described in paragraph (A1), wherein the content indicates one or more questions included in the received message.

(A3) An apparatus as described in paragraph (A2), wherein the content indicates responses to the one or more questions.

(A4) An apparatus as described in any one of paragraphs (A2) through (A3), wherein the outcome indicates whether or not text of the another message is relevant to the one or more questions.

(A5) An apparatus as described in any one of paragraphs (A2) through (A4), wherein providing the outcome to the computing device comprises causing the computing device to: display, within an interface used to compose the another message, the outcome, and highlight, within the outcome, a portion of text of the received message not addressed by text of the another message.

(A6) An apparatus as described in any one of paragraphs (A1) through (A5), wherein determining the outcome comprises determining the outcome using one or more natural language processing (NLP) models, and wherein the one or more NLP models include one of more of: a general language model and a valid response model.

(A7) An apparatus as described in any one of paragraphs (A1) through (A6), wherein the plurality of messages comprise one or more of: email messages, text messages, or chatroom messages.

(A8) An apparatus as described in any one of paragraphs (A1) through (A7), wherein providing the outcome comprises autocompleting the prompt.

The following paragraph (CRM1) describes examples of computer-readable media that may be implemented in accordance with the present disclosure.

(CRM1) A non-transitory computer-readable medium storing instructions that, when executed, cause a system to: generate an input based on a plurality of messages, the input including content of the plurality and a prompt for an outcome, the plurality of messages including a received message and another message yet to be sent, and the outcome indicative of a level of responsiveness of the another message to the received message; determine the outcome responsive to the prompt based on the content of the plurality of messages included in the input; and provide the outcome to a computing device before transmission of the another message, the outcome to enable modification the another message to adjust responsiveness of the another relative to the received message.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method comprising:
generating an input based on a plurality of messages, the input including content of the plurality and a prompt for an outcome, the plurality of messages including a received message and another message yet to be sent, and the outcome indicative of a level of responsiveness of the another message to the received message;
determining the outcome responsive to the prompt based on the content of the plurality of messages included in the input; and
providing the outcome to a computing device before transmission of the another message, the outcome to enable modification the another message to adjust responsiveness of the another message relative to the received message.

2. The method of claim 1, wherein the content indicates one or more questions included in the received message.

3. The method of claim 2, wherein the content indicates responses to the one or more questions.

4. The method of claim 2, wherein the outcome indicates whether or not text of the another message is relevant to the one or more questions.

5. The method of claim 2, wherein providing the outcome to the computing device comprises causing the computing device to:
display, within an interface used to compose the another message, the outcome, and
highlight, within the outcome, a portion of text of the received message not addressed by text of the another message.

6. The method of claim 1, wherein determining the outcome comprises determining the outcome using one or more natural language processing (NLP) models, and wherein the one or more NLP models include one of more of: a general language model and a valid response model.

7. The method of claim 1, wherein the plurality of messages comprise one or more of: email messages, text messages, or chatroom messages.

8. The method of claim 1, wherein providing the outcome comprises autocompleting the prompt.

9. The method of claim 1, wherein the content is sent by a client device in response to receiving, at the client device, a user input indicating that the another message should be sent.

10. The method of claim 1, wherein the content is sent by a client device in real time as the another message is composed.

11. The method of claim 1, further comprising:
receiving, along with the content, additional content indicating previous messages included on a messaging string along with the received message and the another message, wherein generating the input further comprises generating, based on the additional content, the input.

12. A computing system comprising:
a processor;
memory storing computer executable instructions that, when executed by the processor, cause the computing system to:
generate an input based on a plurality of messages, the input including content of the plurality and a prompt for an outcome, the plurality of messages including a received message and another message yet to be sent, and the outcome indicative of a level of responsiveness of the another message to the received message;
determine the outcome responsive to the prompt based on the content of the plurality of messages included in the input; and
provide the outcome to a computing device before transmission of the another message, the outcome to enable modification the another message to adjust responsiveness of the another message relative to the received message.

13. The computing system of claim 12, wherein the content indicates one or more questions included in the received message.

14. The computing system of claim 13, wherein the content indicates responses to the one or more questions.

15. The computing system of claim 13, wherein the outcome indicates whether or not text of the another message is relevant to the one or more questions.

16. The computing system of claim 13, wherein providing the outcome to the computing device comprises causing the computing device to:
display, within an interface used to compose the another message, the outcome, and
highlight, within the outcome, a portion of text of the received message not addressed by text of the another message.

17. The computing system of claim 12, wherein determining the outcome comprises determining the outcome using one or more natural language processing (NLP) models, and wherein the one or more NLP models include one of more of: a general language model and a valid response model.

18. The computing system of claim 12, wherein the plurality of messages comprise one or more of: email messages, text messages, or chatroom messages.

19. The computing system of claim 12, wherein providing the outcome comprises autocompleting the prompt.

20. One or more non-transitory computer-readable media storing instructions that, when executed by a computing system comprising at least one processor, a communication interface, and memory, cause the computing system to:
generate an input based on a plurality of messages, the input including content of the plurality and a prompt for an outcome, the plurality of messages including a received message and another message yet to be sent, and the outcome indicative of a level of responsiveness of the another message to the received message;
determine the outcome responsive to the prompt based on the content of the plurality of messages included in the input; and
provide the outcome to a computing device before transmission of the another message, the outcome to enable modification the another message to adjust responsiveness of the another message relative to the received message.
